(19) United States
(12) Patent Application Publication
(10) Pub. No.: US 2026/0200231 A1
(43) Pub. Date: Jul. 16, 2026

(54) INK RETURN VALVE DRYOUT PREVENTION

(71) Applicant: Xerox Corporation, Norwalk, CT (US)

(72) Inventors: Christine A STEURRYS, Williamson, NY (US); Peter M GULVIN, Webster, NY (US); Robert E ROSDAHL, Jr., Ontario, NY (US); Mark C PETROPOULOS, Webster, NY (US); Jorge A ALVAREZ, Webster, NY (US); Seemit PRAHARAJ, Webster, NY (US); Jason M LEFEVRE, Penfield, NY (US); Varun SAMBHY, Pittsford, NY (US); Douglas K HERRMANN, Webster, NY (US); Anthony S CONDELLO, Webster, NY (US)

(21) Appl. No.: 19/020,388

(22) Filed: Jan. 14, 2025

(51) Int. Cl. B41J 2/17; B41J 2/165; B41J 2/175; B41J 29/393

(52) U.S. Cl. CPC B41J 2/1707; B41J 2/1721; B41J 2/17596; B41J 29/393; B41J 2002/16594

(57) ABSTRACT

A production inkjet printer system and method for purging ink from a print head manifold. The method includes driving ink into a print head manifold, through the manifold, through an ink return line from the manifold, and through an in-line return valve downstream from the manifold, and thereby into an ink waste tank of the production inkjet printer system. A pump pumps, sprays, and flushes aqueous wiper fluid or an ink-diluting solvent (AWF) from an AWF reservoir into, through a region of the ink return line proximate to the in-line return valve, and therefrom flowing the AWF into the ink waste tank. The flushing can include pumping AWF directly into the region of the ink return line proximate to the in-line return valve or spraying AWF into an opening of an output port of the in-line return valve, or both.

### TECHNICAL FIELD

The present disclosure generally relates to aqueous inkjet print technology, and more specifically to production inkjet printer systems, inkjet printer devices, and methods, that feed ink to a print head by capillary action in a closed ink fluid flow system and expel ink drops from each inkjet nozzle's orifice by overcoming a meniscus of the ink fluid.

### BACKGROUND

In some production inkjet systems ink is fed to the print head by capillary action which requires a closed system (e.g., ink fluid without air being trapped in the print head) to function correctly. The ink path typically includes a return ink-waste line (also referred to as a return ink line or a return line) that feeds ink from a print head manifold to a waste tank during a manifold purge operation. A manifold purge is performed when new print heads are installed or when air needs to be removed from the ink path, including the print head. Because this ink path may not be used frequently, ink can dry in the ink path between the return line and the waste tank. When this happens, a return line valve may not operate properly, and a large volume of air might be allowed into the ink line.

The above condition can result in low pressure in the print head, causing an inability to maintain the meniscus of the ink fluid, ineffective purges of the manifold, and air being trapped in the print head, which can result in missing jets that are not purgeable. It may also cause high pressure faults in the print head if the valve is stuck open, which may allow ink to drain from the head.

### BRIEF SUMMARY

According to various embodiments of the invention, a method is provided for preventing ink in an ink return line proximate to an ink return valve from drying out in an inkjet printer system. The method comprises: receiving, at a controller of an inkjet printer system, a manifold purge instruction to invoke a manifold purge operation to purge ink from a print head manifold in the inkjet printer system, wherein a manifold ink outlet port is fluidly coupled with an ink return line for purging ink from the manifold to an ink waste tank during the manifold purge operation; and flushing, based on receiving the manifold purge instruction, with aqueous wiper fluid or an ink-diluting solvent (both also referred to as AWF), the ink return line at an ink return line region proximate to an in-line return valve, and therefrom flowing the AWF into an ink waste tank of the inkjet printer system.

According to various embodiments, a production inkjet printer system comprises: a print head including a manifold fluidly coupled to a manifold ink input line and separately to a manifold ink purge output line (also referred to as a return line); a return valve that is normally closed and in-line connected with the return line downstream from the manifold; a first pump for driving ink from an ink reservoir, through the manifold ink input line, through the manifold, through the return line, through the return valve, and thereby through an end of the return line where it enters an ink waste tank of the production inkjet printer system; a second pump for pumping aqueous wiper fluid, or an ink-diluting solvent, (also referred to as AWF) from an AWF reservoir to a return line region proximate to the return valve; and an inkjet system controller, is operatively coupled to memory, the return valve, the first pump, and the second pump. The inkjet system controller, in response to executing program instructions, performs a method comprising: invoking a manifold purge operation by: actuating the first pump and opening the return valve; closing the return valve and turning OFF the first pump, after determining an end to the manifold purge operation; turning ON the second pump, after closing the return valve to start an AWF flush operation, and flushing with AWF the return line region proximate to the return valve, and therefrom flowing the AWF into the ink waste tank.

Features and advantages of the above-described various embodiments will become readily apparent from the following description and accompanying drawings. Certain preferred embodiments of the invention and their benefits will also become more apparent to a person of ordinary skill in the art through the description and selected examples given herein below, and through the appended claims.

All references, publications, patents, and patent applications, cited herein and/or cited in any accompanying Information Disclosure Statement (IDS), are hereby incorporated herein by reference in their entirety for all purposes.

### BRIEF DESCRIPTION OF THE DRAWINGS

The accompanying figures, in which like reference numerals refer to identical or functionally similar elements throughout the separate views, and which together with the detailed description below are incorporated in and form part of the specification, serve to illustrate various examples and to explain various principles and advantages all in accordance with the present disclosure, in which:

FIG. 1 is an illustration of two example embodiments of the invention in a production inkjet printer system as shown;

FIG. 2 is an illustration of a third example embodiment of the invention in a production inkjet printer system;

FIG. 3 is a more detailed illustration of the example print head manifold in FIGS. 1 and 2;

FIG. 4 is a block diagram of an information processing system suitable for use in the examples shown in FIGS. 1 to 3, according to various embodiments of the invention; and

FIG. 5 is an operational flow diagram illustrating various methods of operation for the information processing system of FIG. 4, according to various embodiments of the invention.

### DETAILED DESCRIPTION

As required, detailed embodiments are disclosed herein; however, it is to be understood that they are merely examples and that the devices, systems, and methods described herein can be embodied in various forms. Therefore, specific structural and functional details disclosed herein are not to be interpreted as limiting but merely as a basis for the claims and as a representative basis for teaching one of ordinary skill in the art to variously employ the disclosed subject matter in virtually any proprietary detailed structure and function. Further, the terms and phrases used herein are not intended to be limiting but rather to provide an understandable description. Additionally, unless otherwise specifically expressed or clearly understood from the context of use, a term used herein describes the singular and/or the plural of that term.

### Non-Limiting Definitions

The terms “aqueous wiper fluid”, “AWF”, and the like, are intended to mean herein any aqueous fluid (e.g., deionized water) and/or solvent that can be sprayed and/or pumped into, and can flow in, the return line and the waste reservoir and main waste tank assembly of an inkjet printer device or system.

The term “degasser” is intended to mean herein a device that removes dissolved gases (e.g., air) from ink fluid (e.g., pigmented aqueous inks) used in an inkjet printer device.

As used herein, “vertical” or “vertically” refers to a direction perpendicular to the surface of a substrate structure, such as perpendicular to the following non-limiting examples: a planar working surface of the print head, a print substrate medium, and the waste tray in an inkjet printer device. As used herein, “horizontal” or “horizontally” refers to a direction parallel to a surface of a substrate structure, such as horizontal to the following non-limiting examples: a planar working surface of the print head, a print substrate medium, and the waste tray in an inkjet printer device.

### Introduction

Various inkjet printer devices and production inkjet printer systems feed aqueous ink to a print head by capillary action in a closed ink fluid flow system. The inkjets in the print head expel ink drops from each inkjet nozzle's orifice by overcoming a meniscus of the ink fluid. The ink path typically includes a return ink-waste line (also referred to as a return ink line or a return line) that occasionally during a manifold purge operation flows ink from the print head manifold to an ink waste reservoir. The ink from the ink waste reservoir then flows to a main ink waste tank during the manifold purge operation.

A manifold purge operation might be performed at a production inkjet printer system for various different conditions. Ink can dry in the ink path at the return valve and downstream in the ink path until it reaches the main ink waste tank. When this dry ink condition occurs proximate to the return valve, the return line valve may not operate properly, and a large volume of air might be allowed into the ink return line and possibly into the print head. When air is allowed in, but the return valve finally closes this causes trapped air which tends to cause a low pressure condition in the ink path upstream from the return valve. If the valve is completely stuck open, this will cause a high pressure condition. High pressure affects the meniscus in opposite ways and may cause ink to leak from the printhead.

Both high and low pressure affect the ability to maintain the meniscus. Low pressure raises the meniscus, which can lead to air ingestion through the nozzles, causing missing jets which may be unpurgeable. High pressure forces the meniscus lower, causing ink to drool from the print head faceplate. The drool, in turn, causes missing jets, which will not jet properly through the ink on the faceplate. These missing jets are recoverable once the pressure has normalized and the faceplate is cleaned. Either high and low pressure can lead to ineffective purges. Besides the inability to maintain the proper meniscus of the ink fluid at the inkjet nozzles in the print head, other side effects can include ineffective purges of the manifold in the print head and air being trapped in the print head, which can result in missing inkjets (e.g., clogged inkjet orifices) that may not be purgeable.

Faint or streaky prints can be a sign of a clogged nozzle which typically happens due to underpressure. A spot on the print is usually due to dripped ink caused by overpressure. All are signs of a failed ink waste return valve.

Additionally, in certain embodiments, underpressure and overpressure faults might be detected in system 102 which would shut down system 102 when the pressure is out of line. This possibly prevents many of the side effects. However, these faults cause machine downtime, which reduces machine productivity. In any case, underpressure and overpressure conditions may lead to premature print head replacements.

This can additionally result in time-consuming and messy cleanings of the print head 124, the ink waste reservoir 154 assemblies (e.g., including the ink waste reservoir container, output lines 156, ink waste pump 157, and control valves), and the main ink waste tank 132 assemblies (e.g., including input lines 156 and control valves). It can also result in a failure mode that leads to lengthy service calls and premature print head replacements. The above problems can detrimentally impact a production inkjet system's quality and commercial viability.

To effectively address the above problems, various embodiments of the invention pump and/or spray aqueous wiper fluid (e.g., deionized water) into a region of the return line near the return valve or spray directly on the downstream side of the return valve. The aqueous wiper fluid therein wets and dilutes any dried ink in the ink path. Then, the aqueous wiper fluid flows down through the portion of the return line near the return valve and continues flowing down through the ink output reservoir and into the main ink waste tank. This effectively avoids dried ink being present in the return line, and accordingly, the return valve can operate correctly. It also effectively avoids dried ink in the ink waste reservoir 154 assemblies and the main ink waste tank 132 assemblies.

### Various Examples of Inkjet Printer Systems And Methods

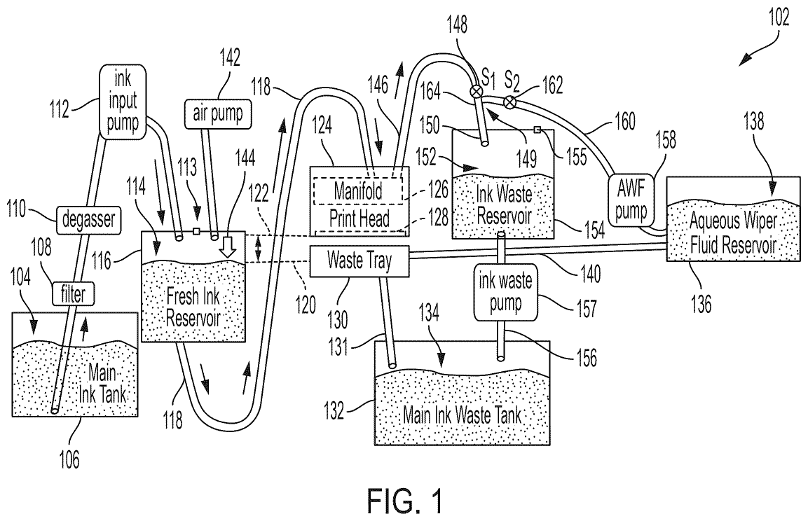

Referring to FIG. 1, a first example embodiment of the invention includes an ink path in a production inkjet printer system 102 as shown. It should be understood, however, that various embodiments of the present invention similarly anticipate other types of inkjet printer systems.

Ink 104 from a main ink tank 106 is pumped out by an ink reservoir input pump 112 as indicated by the arrow. In various embodiments the ink can be an aqueous ink fluid. The ink 104 is filtered by an ink filter 108 and degassed by a degassing module 110. The ink reservoir input pump 112 then pumps the ink 104 into a fresh ink reservoir 116 as indicated by the arrow. While ink 104 continues to fill the fresh ink reservoir 116, an air pressure controllable solenoid valve 113 is normally open providing an air hole 113 toward the top of the fresh ink reservoir 116 which allows air to flow through the air hole 113, equalizing air pressure inside the fresh ink reservoir 116. The air hole 113 equalizing air pressure allows ink 104 to be pumped into the fresh ink reservoir 116. The air hole 113 equalizing air pressure also allows ink 104 to flow out of the fresh ink reservoir 116 through an ink reservoir output line 118 (also referred to as a manifold ink input line).

The ink 114 pumped into the fresh ink reservoir 116 fills the fresh ink reservoir 116 up to a level 120. The ink 114 from the fresh ink reservoir 116 flows through a reservoir output line 118, as indicated by the arrows. The ink 114 then flows through the output line 118 and into a manifold 126 inside a print head 124, as indicated by the arrow. The print head 124 contains a horizontal inkjet stack 128 arranged vertically below the manifold 126. The ink 114 flows downward from the manifold 126 through a set of small openings a the bottom surface of the manifold 126. The ink 114 then flows into the inkjet nozzles of the horizontal inkjet stack 128. The ink 114 flowing into the inkjet nozzles reaches orifices of the inkjet nozzles located at the bottom surface of the horizontal inkjet stack 128. The ink 114 at the orifices at the bottom surface of the horizontal inkjet stack 128 is typically vertically located at a level 122 just above the level 120 of the ink 114 in the fresh ink reservoir 116. The ink 114 is typically drawn from the fresh ink tank 116, through this ink path, by capillary action during printing.

Print head 124 can thereby print ink 114 onto a horizontal substrate media (not shown) located vertically just below the print head 124, based on pressure placed in the ink 114 by a piezo (not shown) and the meniscus of the ink 114 in each inkjet orifice. The meniscus location is a balance created by gravity, the negative pressure in the print head and the surface tension difference between ink and the printhead faceplate coating. A waste tray 130 vertically below the horizontal inkjet stack 128 (and vertically below any horizontal substrate media therebetween) collects residual ink 114 from the print head 124, and then a waste tray output line 131 empties the ink waste 134 into a main waste tank 132 as shown in FIG. 1.

According to the example, an aqueous wiper fluid (AWF) reservoir 136 contains aqueous wiper fluid 138, which can flow through an AWF output line 140 to the waste tray 130 and thereby mix with any ink waste 134 in the waste tray 130, which then empties the ink waste 134 into the main waste tank 132. The flow of AWF 138 through the AWF output line 140 can be controlled by the system 102 opening or closing a solenoid valve (not shown) mechanically coupled with the AWF output line 140. A primary purpose of AWF is to clean the wiper blades and cap, which are part of the waste tray. They come in contact with the print head during operation. Dried ink on the wiper blade will affect its ability to clean the faceplate, leading to missing jets. AWF also keeps the drain lines clean.

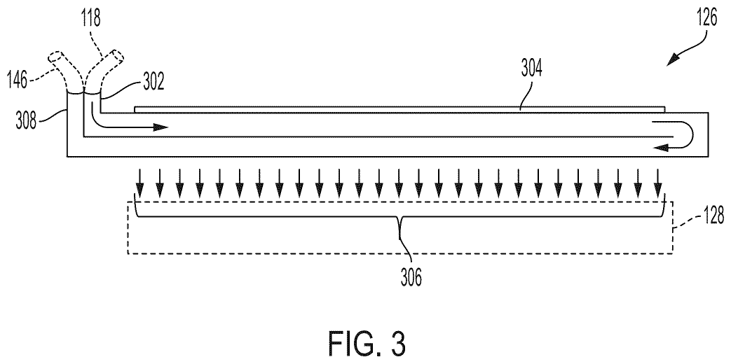

While more commonly, an operator or service person initiates a manifold purge at a production inkjet printer system 102, when the production inkjet printer system 102 determines it is time for a manifold purge operation, according to the present example, system 102 sends a control signal to the air pressure controllable valve 113. It thereby closes the air pressure controllable valve 113, which, while normally open provides an air hole 113 to equalize the air pressure in the fresh ink reservoir. Then, system 102 turns ON a compressor air pump 142 with an output air-coupled to an upper region of the fresh ink reservoir 116 above a fill level 120 of the ink 114 in the ink reservoir 116. The pumping by the compressor air pump 142 creates pneumatic air pressure 144 (the pump pumps air) above the ink 114 in the fresh ink reservoir 116. The air pressure 144 drives (with pneumatic air pressure driving force) ink 114 through the output line 118 from the fresh ink reservoir 116 into the manifold 126 in the print head 124. Ink 114 enters the manifold 126 with a relatively low fluid force such that it does not overcome the capillary force of the inkjet nozzles in the horizontal inkjet stack 128, resulting in the ink 114 mostly flowing through a manifold ink output (also referred to as a manifold ink outlet port or simply a manifold ink outlet, and the like) 308 (shown in FIG. 3) which is fluidly coupled with a manifold ink purge output line 146 (also referred to as an ink return line or simply a return line), as indicated by the arrow.

The return line 146 includes a controllable solenoid valve 148 (also called a controllable return valve or simply a return valve, and the like), that is normally closed. That is, an input of the return valve 148 and an output of the return valve 148 are in-line fluidly coupled with the return line 146. A reference herein to the portion of the return line 164 proximate to the return valve 148, unless clearly understood to be different based on the context of the reference, includes the return valve 148. It should be noted that in certain embodiments, there can be an additional controllable solenoid valve (not shown) in line with the return line 146 and upstream from the return valve 148.

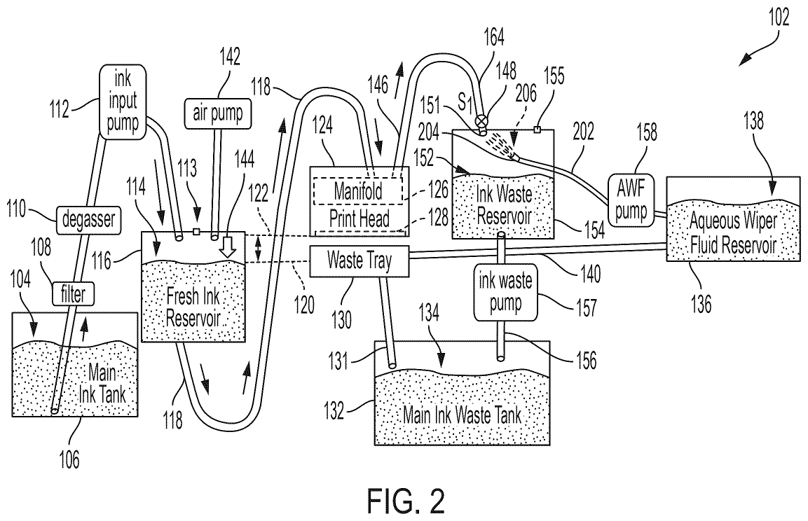

During a manifold purge operation, according to various embodiments, system 102 opens the return valve 148, allowing ink 114 to flow through the return line 146, the return valve 148, and out of the end of the return line 150 into an ink waste reservoir 154 (also referred to as an ink waste tank), such as illustrated in FIG. 1. In various embodiments, such as illustrated in FIG. 2, the output 151 of the return valve 148 can directly couple to the ink waste reservoir 154, and thereby allows ink 114 to flow out of the output 151 of the return valve 148 directly into the ink waste reservoir 154.

While ink 152 continues to fill the ink waste reservoir 154, an air hole 155 toward the top of the ink waste reservoir 154 allows air to flow, equalizing air pressure inside the ink waste reservoir 154. The equalized air pressure allows ink 152 to continue filling the waste reservoir 154. The air hole 155 equalizing air pressure in the ink waste reservoir 154 also allows ink 152 to be pumped by an ink waste pump 157 from the ink waste reservoir 154, through a waste ink output line 156, and into the main ink waste tank 132. When the manifold purge operation has ended, the system 102 turns OFF the compressor air pump 142 and opens the air pressure controllable solenoid valve 113 to create an air hole 113 toward the top of the fresh ink reservoir 116. The system 102 also closes the return line solenoid valve (return valve) 148, preventing air from entering the return line 146 and possibly reaching the print head 124.

A manifold purge operation is typically performed when new print heads are installed or when air needs to be removed from the ink flow path in system 102. However, a manifold purge operation can be performed at other times and for different conditions. For example, a manifold purge operation can be manually started by an inkjet printer device user (e.g., an operator or service person).

Because a manifold purge ink path 146, 164, 148, 150, 154, 157, 156, 132 is typically not used frequently, ink 114 can occasionally dry in the return line region 164 proximate to the return valve 148, in the return valve 148 or an output 151 thereof, or between the return valve 148 and the ink waste reservoir 154. Additionally, ink 152 in the ink waste reservoir 154 can dry out and possibly cause blockage (or partial blockage) in the waste ink output line 156.

When this dry ink condition occurs in the portion of the return line 164 proximate to the return valve 148, the return valve 148 might not close properly. A large volume of air can thereby be allowed into the manifold output line (return line) 146 and possibly reach the print head 124. Such an air leak into the closed ink-flow system can cause various problems. For example, it can cause low pressure in the print head 124, resulting in an inability to maintain the ink fluid meniscus at the inkjet orifices. It can result in ineffective manifold purges because air is compressible while ink is not. When air gets into the print head 124 it can cause missing (clogged or partially clogged) inkjets that are not purged when the air becomes trapped within some areas of the inkjets. Faint, streaky, or spotty prints are all common signs of a clog. When one or more of these problems occur, it can result in time-consuming and messy cleanings of the ink waste reservoir 154 assemblies (e.g., including the ink waste reservoir container, output lines 156, ink waste pump 157, and control valves) and the main ink waste tank 132 assemblies (e.g., including input lines 156 and control valves). It can also result in a failure mode that leads to lengthy service calls and premature print head replacements.

Various embodiments of the present invention can avoid the above-mentioned problems and failure mode. Example embodiments will be more fully discussed below.

Continuing with reference to the first example embodiment in FIG. 1, aqueous wiper fluid (AWF) pump 158 has an input coupled to an output line from the AWF reservoir 136. The AWF pump 158 has an output fluidly connected to an AWF output line 160, which is fluidly connected to an input of an AWF solenoid valve (also referred to as AWF output valve) 162. The AWF solenoid valve 162 is normally closed. According to the first example, an output of the AWF solenoid valve 162 is fluidly coupled to the return line region 164 proximate to the return valve 148, at a location 149 downstream from the return valve 148. It should be noted that in a second example embodiment the output of the AWF solenoid valve 162 is fluidly coupled to the return line region 164 proximate to the return valve 148 at a location (not shown) upstream from the return valve 148, which will be more fully discussed below.

When the system 102, in the first example, is in a manifold purge operation, with the return valve 148 closed, the system 102 can turn ON the AWF pump 158, open the AWF solenoid valve 162, and thereby pump, spray, and flush aqueous wiper fluid into the portion of the return line 164 (such as at connection point 149 in FIG. 1) proximate to, and downstream from, the return valve 148 such as shown in FIG. 1. It is understood that system 102 can pump, spray, and flush the aqueous wiper fluid into the portion of the return line 164 at a time outside of a manifold purge operation. The aqueous wiper fluid, in the first example, mixes with the ink 114 (including wetting any dried ink 114) in the portion of the return line 164 proximate to an output of the return valve 148 and then flows, along with any ink 114 therein, into the ink waste reservoir 154 and through the ink waste pump 157 and the ink waste reservoir output line 156 into the main ink waste tank 132. The AWF flowing in the ink waste reservoir 154, through the ink waste pump 157 and the ink waste reservoir output line 156, and into the main ink waste tank 132, additionally wets and clears any dried ink in that ink path.

According to a second example embodiment of the invention, with reference to FIG. 1, the output of the AWF solenoid valve 162 is fluidly coupled to the return line region 164 proximate to the return valve 148, at a location upstream from the return valve 148. The aqueous wiper fluid, in this example, additionally flows, along with any ink in the return line region 164, through the return valve 148. Then, as in the first example embodiment, the aqueous wiper fluid flows down into the waste reservoir 154, through the ink waste reservoir output line 156, and into the main ink waste tank 132.

At the end of a manifold purge operation, in the example, with another solenoid valve (not shown) closed upstream from the return valve 148 and with the return valve open, the system 102 opens the AWF solenoid valve 162, allowing AWF to flow into the return line region 164 proximate to the return valve 148, and through the return valve 148, and after a defined time interval of flowing the AWF, in this second example, the system 102 closes the AWF solenoid valve 162 and closes the return valve 148. In this example, the other solenoid valve (not shown) is opened allowing ink 114 to flow downstream to the closed return valve 148.

It should be understood that a combination of the first and second example embodiments is also anticipated by the present disclosure. That is, aqueous wiper fluid can be contemporaneously pumped, sprayed, and flushed into the return line region 164 proximate to the return valve 148 both at an upstream location and at a downstream location 149. Then, similar to the first and second example embodiments, the aqueous wiper fluid flows down into the ink waste reservoir 154, through the ink waste pump 157, the ink waste reservoir output line 156, and into the main ink waste tank 132. It should be noted that in certain embodiments at least some of the AWF remains in the ink waste reservoir after an AWF cleaning. It would stay there until the next manifold purge when it gets pumped out by the ink waste pump 157 before the ink begins to flow.

By pumping, spraying, and flushing aqueous wiper fluid in the return line region 164 proximate to the return valve 148, either upstream or downstream 149 from the return valve 148, the aqueous wiper fluid mixes with any ink 114 in the return line region 164 proximate to the return valve 148. The aqueous wiper fluid flowing in the return line region 164 clears the path for the ink 114 to flow and for the return valve 148 to operate correctly. This effectively avoids the problems and failure mode discussed above.

Referring to FIG. 2, in a third example embodiment of the invention, the AWF pump 158 output is connected to an AWF output line 202, connected to a sprayer nozzle 204 oriented toward (oriented to spray AWF into) an opening 151 of an output of the return valve 148 which is directly fluidly coupled to an upper region of the ink waste reservoir 154. An input of the return valve 148 is fluidly coupled to, and in-line with, the return line 146 as shown in FIG. 2.

In this example, with the return valve 148 closed, the AWF pump 158 pumps aqueous wiper fluid through the AWF output line 202 and the sprayer nozzle 204, and thereby aqueous wiper fluid 206 is pumped, sprayed, and flushed into the opening 151 of the output of the return valve 148. By pumping, spraying, and flushing aqueous wiper fluid 206 into the opening 151 of the output of the return valve 148, such as during a manifold purge operation, the flushing aqueous wiper fluid can backflow into the output of the return valve 148. This backflow of aqueous wiper fluid clears the path from any dried ink 114 in the output of the return valve 148, which also allows the return valve 148 to operate correctly. When the return valve is open, during a manifold purge operation, the ink 114 can flow into the ink waste reservoir 154. It is understood that system 102 can pump, spray, and flush the aqueous wiper fluid into the opening 151 of the output of the return valve 148 at a time outside of a manifold purge operation. Pumping, spraying, and flushing aqueous wiper fluid into the opening 151 of the output of the return valve 148 effectively avoids the abovementioned problems and failure mode. At the end of a manifold purge operation, in this example, system 102 turns OFF the AWF pump 158 while the return valve 148 remains closed.

It should be understood that any combination of the first, second, and third example embodiments is also anticipated by the present disclosure. That is, aqueous wiper fluid can be contemporaneously (or in any desired sequence) pumped, sprayed, and/or flushed into the return line region 164 proximate to the return valve 148, at an upstream location, at a downstream location 149, and additionally can be sprayed into the opening 151 of the return valve 148 and flushed proximate to the return valve 148. Contemporaneously, the aqueous wiper fluid can flow down from the end of the return line region 164, and/or the output 151 of the return valve 148, into the ink waste reservoir 154, through the ink waste pump 157, the ink waste reservoir output line 156, and into the main ink waste tank 132.

Additionally, or alternatively, to the above describe examples, in certain embodiments that can use aqueous ink fluid 114, the aqueous ink fluid 114 can be pumped and flushed through the return line 146 for an extended amount of time to wet any dried ink 114 in the return valve 148, and/or in the portion of the return line 164 proximate to an output of the return valve 148, until a sensor (not shown) senses the normally-closed return valve 148 changing state from being open to being closed, thereby maintaining a sealed system (sealed from external air) throughout the ink path from the output of the manifold 126 to the output of the return valve 148. That is, for example, the aqueous ink fluid 114 can flow (including wetting any dried ink 114) in the portion of the return line 164 proximate to an output of the return valve 148 and then continues to flow, along with any ink 114 therein, into the ink waste reservoir 154 and through the ink waste pump 157 and the ink waste reservoir output line 156 into the main ink waste tank 132.

FIG. 3 shows a more detailed view of the example print head manifold 126 in FIGS. 1 and 2. Output line 118 from the ink reservoir 116 is coupled to a manifold ink input 302 (also referred to as a manifold ink inlet port or simply as a manifold ink inlet, and the like). The ink 114 flows from the output line 118, through the manifold ink inlet 302, and into the manifold 126, as indicated by the arrow. The manifold 126 includes a heating coil structure (also referred to as a heater) 304 adjacent to the path of the ink 114 as it flows into and through the manifold 126. The heating coil structure 304 raises the temperature of the ink 114 as it flows through the manifold 126 and across a set of small input openings 306 distributed horizontally across the top surface of the horizontal inkjet stack 128. These openings 306 will distribute the ink 114 flowing downward, typically by capillary action, out from the bottom of the manifold 126 and into the top of the horizontal inkjet stack 128, and into the inkjet nozzles and their orifices.

During a manifold purge operation, the ink 114 enters the manifold ink inlet 302 with a relatively low fluid force such that it does not overcome the capillary force of the inkjet nozzles in the horizontal inkjet stack 128, resulting in the ink 114 mostly flowing through a manifold ink purge output 308 (also referred to as a manifold ink purge outlet port or simply as a manifold ink outlet, and the like) coupled to the manifold ink purge output line (also referred to as an ink return line or simply a return line, and the like) 146, as has been discussed above with reference to FIG. 1.

### Example of a Production Inkjet Printer System Including an Information Processing System Operating in a Network

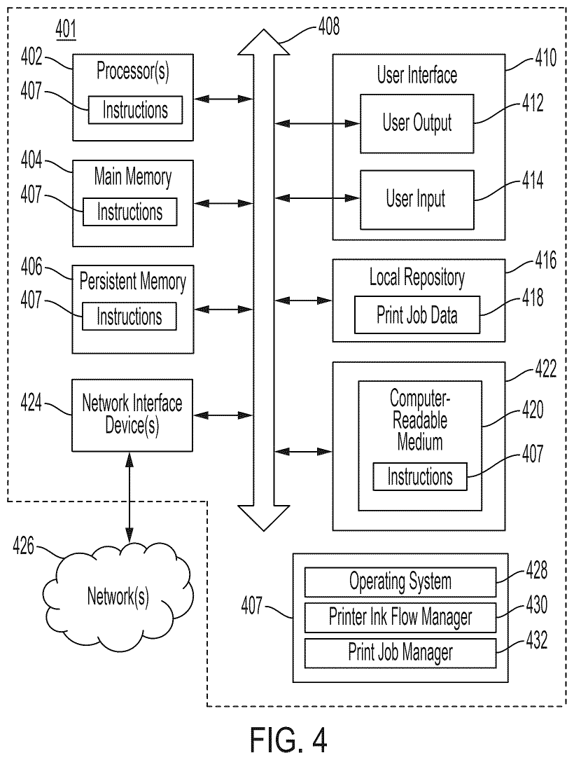

FIG. 4 illustrates an example of a processing system 401 (also referred to as a computer system) suitable for use to perform the example methods discussed herein for a production inkjet printer system, according to an example of the present disclosure. The processing system 401, according to the example, is communicatively coupled with a communication network 426, which can comprise a plurality of networks. This simplified example is not intended to suggest any limitation regarding the scope of use or function of various example embodiments of the invention described herein.

The example processing system 401 comprises a computer system/server, which is operational with numerous other general-purpose or special-purpose computing system environments or configurations. Examples of well-known computing systems, environments, and/or configurations that may be suitable for use with such a computer system/server include, but are not limited to, personal computer systems, server computer systems, thin clients, thick clients, hand-held or laptop devices, multiprocessor systems, microprocessor-based systems, and distributed cloud computing environments that include any of the above systems and/or devices, and the like.

The processing system 401 may be described in a general context of computer system executable instructions, such as program modules, being executed by a computer system. Generally, program modules may include methods, functions, routines, programs, objects, components, logic, data structures, and so on that perform particular tasks or implement particular abstract data types. A processing system 401, according to various embodiments, may be practiced in distributed networking environments where tasks are performed by remote processing devices linked through a communications network.

Referring more particularly to FIG. 4, the following discussion will describe a more detailed view of an example processing system 401. According to the example, at least one processor 402 (also referred to as controller) is communicatively coupled with system main memory 404 and persistent memory 406.

A bus architecture 408 facilitates communicative coupling between the at least one processor 402 and the various component elements of the processing system 102. The bus architecture 408 represents one or more types of bus structures, including a memory bus, a peripheral bus, an accelerated graphics port, and a processor bus or local bus using various bus architectures.

The system main memory 404, in one example, can include computer system readable media in the form of volatile memory, such as random access memory (RAM) and/or cache memory. By way of example only, a persistent memory storage system 406 can be provided for reading from and writing to any one or more of: a non-removable, non-volatile magnetic media (not shown and typically called a “hard drive”), or a solid state drive (SSD) (also not shown), or both. In such instances, each persistent memory storage system 406 can be connected to the bus architecture 408 by one or more data media interfaces. As will be further depicted and described below, the at least one processor 402, the main memory 404, and the persistent memory 406, may include a set (e.g., at least one) of program modules (instructions) 407 that can be configured to carry out functions and features of various embodiments of the invention.

A program/utility, having a set (at least one) of program modules, may be stored in persistent memory 406 by way of example, and not limitation, as well as an operating system 428, one or more application programs or applications such as a Printer Ink Flow Manager 430, a Print Job Manager 432, and other program modules, and program data. Each of the operating system 428, one or more application programs 430, 432, other program modules, and program data, or some combination thereof, may include an implementation of interface software to a networking environment. Program modules generally may carry out the functions and/or methodologies of various embodiments of the invention as described herein.

The at least one processor/controller 402 is communicatively coupled with one or more network interface devices 424 via the bus architecture 408. The network interface device 424 is communicatively coupled, according to various embodiments, with one or more networks 426. The network interface device 424 can communicate with one or more networks 426 such as a local area network (LAN), a general wide area network (WAN), and/or a public network (e.g., the Internet). The network interface device 424, according to the example, facilitates communication between the processing system 401 and other nodes in the network(s) 426, such as for a distributed production inkjet printer system.

For example, the processor 402, according to various embodiments, can interoperate with the print job manager 432 and send print job data 418 stored in a local repository 416 to an inkjet printer device that prints, according to the print job data 418, onto print media substrate(s) located below and close to the horizontal inkjet stack 128 in the print head 124.

A user interface 410 is communicatively coupled with the processor 402, such as via the bus architecture 408. The user interface 410, according to the present example, includes a user output interface 412 and a user input interface 414. Examples of user output interface 412 elements can include a display, a speaker, one or more indicator lights, one or more transducers that generate audible indicators, and a haptic signal generator. Examples of user input interface 414 elements can include a keyboard, a keypad, a mouse, a trackpad, a touchpad, and a microphone that receives audio signals. The received audio signals, for example, can be converted to electronic digital representation and stored in memory, and optionally can be used with voice recognition software executed by the processor 402 to receive user input data and commands.

Instructions 407 can be partially or entirely stored in various locations in the processing system 401. For example, at least some of the computer instructions 407 may be stored in one or more of the following: an internal cache memory in the processor/controller 402, the main memory 404, and the persistent memory 406.

Instructions 407, according to the example, can include computer instructions, data, configuration parameters, and other information that can be used by the processor/controller 402 to perform features and functions of the processing system 401. According to the present example, the instructions 407 include an operating system 428 which operates to control one or more applications. The instructions 407 also include a Printer Ink Flow Manager application 430 which operates to manage the ink flow through an inkjet printer device including one or more print heads 124. The Printer Ink Flow Manager application 430, in the present example, controls a manifold purge operation, as discussed herein. Instructions 407 also include an application that performs features and functions of system 401 and how it interoperates with other components of a distributed production inkjet printer system. The instructions 407 also include a set of configuration parameters that can be used by the processor/controller 402, the Printer Ink Flow Manager 430, and the Print Job Manager 432, as discussed herein. Additionally, the instructions 407 include configuration data for the processing system 401.

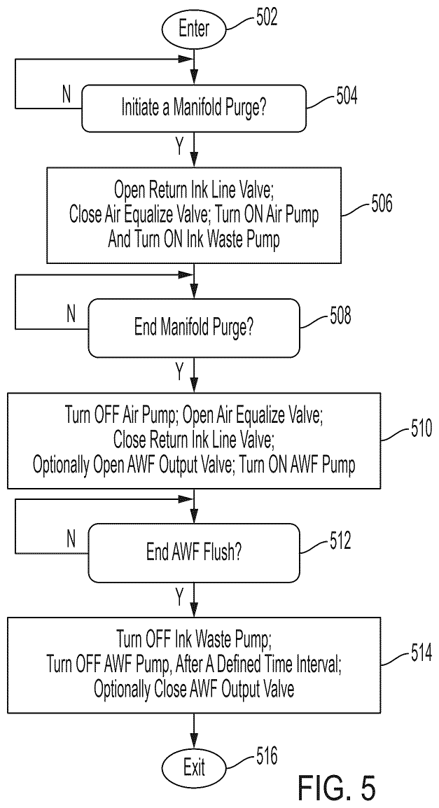

System 401, in this example, includes a computer-readable medium reader/writer device 422 communicatively coupled with the system bus 408 and thereby with the processor 402. The processor 402, using the reader/writer device 422, can read instructions 407 from and write to a non-transitory computer-readable storage medium 420. These computer-readable program instructions 407 are stored in a non-transitory computer-readable storage medium that can direct a computer, a programmable data processing apparatus, and/or other devices to function in a particular manner, such that the computer-readable storage medium 420 having instructions stored therein comprises an article of manufacture (also referred to a computer program product) including instructions 407 which implement aspects of the functions/acts specified in the flow diagram and/or block diagram block or blocks shown in FIGS. 4 and 5.

FIG. 5 is an operational flow diagram illustrating example methods of operation of a production inkjet printer system including a processing system 102 such as shown in FIG. 4.

The processor 402 in the processing system 102 enters the operational sequence shown in FIG. 5, at step 502, and while interoperating with the printer ink flow manager application 430, checks, at step 504, whether it is time to initiate a manifold purge operation. When processor 402 determines, at step 504, it is time to initiate a manifold purge operation, processor 402 proceeds to step 506 to invoke a manifold purge operation. For example, the processor 402 can receive a manifold purge instruction and thereby determine to invoke a manifold purge operation. An operator or service person, such as by operating the user interface 410, can cause such an instructions to invoke the manifold purge operation.

The processor 402 interoperating with the Printer Ink Flow Manager application 430, at step 506, opens the return ink line valve 148, which is normally closed, closes the air pressure equalize controllable valve 113, turns ON the air pump 142, and turns ON the ink waste pump 157.

Continuing with the present example, processor 402 interoperating with the Printer Ink Flow Manager application 430, at step 508, continuously checks whether it is time to end the Manifold Purge operation.

The processor 402, upon determining it is time to end the Manifold Purge operation, at step 508, proceeds to step 510 to turn OFF the air pump 142, open the air pressure equalize controllable valve 113, close the return valve 148, and turn ON the AWF pump 158. The processor 402 thereby starts an AWF Flush operation.

It should be noted that the AWF output valve 162 is an optional feature because it is used in the first and second example embodiments shown in FIG. 1. In contrast, the AWFS output valve 162 is not necessarily used in the third example embodiment shown in FIG. 2. For a more detailed discussion illustrating examples of a manifold purge operation, see the discussion above with reference to FIGS. 1 to 3.

Optionally, in certain embodiments as discussed above with reference to FIG. 1, the processor 402 opens the AWF output valve 162, which is normally closed. In these certain embodiments, the open AWF output valve 162 allows aqueous wiper fluid to be pumped, sprayed, and flushed into to the portion of the return line 164 proximate to the return valve 148. The aqueous wiper fluid mixes with ink 114 (including wetting any dried ink 114) in the portion of the return line 164 and then flows, along with any ink 114 therein, into the ink waste reservoir 154 and through the ink waste pump 157 and the ink waste reservoir output line 156 into the main ink waste tank 132. The aqueous wiper fluid flowing in the return line region 164 clears the path for ink 114 to flow and for the return valve 148 to operate correctly.

In the various embodiments discussed above with reference to FIG. 2, the AWF pump 158 pumps aqueous wiper fluid through the AWF output line 202 and the sprayer nozzle 204, and thereby aqueous wiper fluid 206 is pumped, sprayed, and flushed into the opening 151 of the output of the return valve 148. By pumping, spraying, and flushing aqueous wiper fluid 206 into the opening 151 of the output of the return valve 148, such as during a manifold purge operation, the flushing aqueous wiper fluid can backflow into the output of the return valve 148. This backflow of aqueous wiper fluid clears the path for ink 114 to flow and for the return valve 148 to operate correctly.

Continuing with the present example, processor 402 interoperating with the Printer Ink Flow Manager application 430, at step 512, continuously checks whether it is time to end the AWF Flush operation.

The processor 402, upon determining it is time to end the AWF Flush operation, at step 512, proceeds to step 514 to turn OFF the ink waste pump 157, and after a define time interval turns OFF the AWF pump 158. Optionally, in certain embodiments as discussed above with reference to FIG. 1, the processor 402 closes the AWF output valve 162. When the manifold purge operation ends and the AWF Flush operation ends, processor 402 exits the operational sequence, at step 516.

### Non-Limiting Examples

The present invention may be implemented as a system and/or a method at any possible technical detail level of integration. A computer program may include computer readable program instructions for causing a processor to carry out aspects of the present invention.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages. The computer-readable program instructions may execute entirely as a stand-alone software package, entirely in a production inkjet printer system, or partly in a production inkjet printer device and partly in a user's computer, a remote computer, or a server. In the latter scenario, the remote computer may be connected to the production inkjet printer device and/or the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention are described herein with reference to flow diagram illustrations and/or block diagrams of methods, apparatus (systems), and computer programs according to various embodiments. It will be understood that each block of the flow diagram illustrations and/or block diagrams, and combinations of blocks in the flow diagram illustrations and/or block diagrams, can be implemented by computer-readable program instructions.

These computer-readable program instructions may be provided to a processor of a general-purpose computer, a special-purpose computer, or other programmable data processing apparatus to produce a machine, such that the instructions, which execute via the processor of the computer or other programmable data processing apparatus, implement the functions/acts specified in the flow diagram and/or block diagram block or blocks. These computer-readable program instructions may also be stored in a non-transitory computer-readable storage medium that can direct a computer, a programmable data processing apparatus, and/or other devices to function in a particular manner, such that the computer-readable storage medium having instructions stored therein comprises an article of manufacture (also referred to a computer program product) including instructions which implement aspects of the functions/acts specified in the flow diagram and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process or method, such that the instructions which execute on the computer, other programmable apparatus, or other device implement the functions/acts specified in the flow diagram and/or block diagram block or blocks.

The flow diagram and block diagrams in the Figures illustrate the architecture, functionality, and operation of possible implementations of systems, methods, and computer programs according to various embodiments of the present invention. In this regard, each block in the flowchart or block diagrams may represent a module, segment, or portion of instructions comprising one or more executable instructions for implementing the specified logical function(s). In some alternative implementations, the functions noted in the blocks may occur out of the order noted in the Figures. For example, two blocks shown in succession may be executed substantially concurrently, or the blocks may sometimes be executed in the reverse order, depending upon the functionality involved. It will also be noted that each block of the block diagrams and/or flow diagram illustration, and combinations of blocks in the block diagrams and/or flow diagram illustration, can be implemented by special-purpose hardware-based systems that perform the specified functions or acts or carry out combinations of special purpose hardware and computer instructions.

Although the present specification may describe components and functions implemented in the embodiments with reference to particular standards and protocols, the invention is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might use the structures described herein. Upon reviewing the above description, many other embodiments will be apparent to those of ordinary skill in the art. Other embodiments may be utilized and derived therefrom, such that structural and logical substitutions and changes may be made without departing from the scope of this invention. Figures are also merely representational and may not be drawn to scale. Certain proportions thereof may be exaggerated, while others may be minimized. Accordingly, the specification and drawings should be regarded in an illustrative rather than a restrictive sense.

The Abstract is provided with the understanding that it is not intended to be used to interpret or limit the scope or meaning of the claims. In addition, in the foregoing Detailed Description, various features are grouped in a single example embodiment to streamline the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are incorporated into the Detailed Description, with each claim standing on its own as a separately claimed subject matter.

The terminology used herein is to describe particular embodiments only and is not intended to be limiting to the invention. As used herein, the singular forms “a”, “an” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly and not necessarily mechanically. “Communicatively coupled” refers to the coupling of components such that these components can communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is set up, arranged, built, composed, constructed, designed or that has any combination of these characteristics to carry out a given function. The term “adapted to” describes hardware, software, or a combination of hardware and software that can accommodate, make, or be suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed.

The description of the present application has been presented for illustration and description but is not intended to be exhaustive or limited to the invention in the form disclosed. Many modifications and variations will be apparent to those of ordinary skill in the art without departing from the scope of the invention. The embodiments were chosen and described to explain best the principles of the invention and the practical applications, and to enable others of ordinary skill in the art to understand the invention for various embodiments with various modifications suited to the particular use contemplated.

What is claimed is:

1. A computer-implemented method for preventing ink in an ink return line proximate to an ink return valve from drying out in an inkjet printer system, the method comprising:
receiving, at a controller of an inkjet printer system, a manifold purge instruction to invoke a manifold purge operation to purge ink from a print head manifold in the inkjet printer system, wherein a manifold ink outlet port is fluidly coupled with an ink return line and therethrough an in-line return valve for purging ink from the print head manifold to an ink waste tank during the manifold purge operation; and
flushing, based on receiving the manifold purge instruction, with aqueous wiper fluid or an ink-diluting solvent (both also referred to as AWF), the ink return line at an ink return line region proximate to the in-line return valve, and therefrom flowing the AWF into the ink waste tank of the inkjet printer system.

2. The method of claim 1, further comprises:
opening the in-line return valve during the manifold purge operation;
closing the in-line return valve at an end of the manifold purge operation; and
performing the flushing with AWF after closing the in-line return valve.

3. The method of claim 1, where the flushing comprises spraying the AWF into at least one of an opening of an end of the ink return line, an output port of the in-line return valve, or both, where it enters the ink waste tank and thereby backflowing the AWF in the ink return line, the output port, or both, to reach with AWF the ink return line region proximate to the in-line return valve.

4. The method of claim 1, where the flushing comprises pumping, spraying, and flushing the AWF directly into the ink return line region proximate to, and downstream from, the in-line return valve, and therefrom flowing the AWF through the ink return line and into the ink waste tank of the inkjet printer system.

5. The method of claim 4, wherein an AWF pump has an input and an output, the input fluidly coupled to an AWF reservoir and the output fluidly coupled to the ink return line region proximate to, and downstream from, the in-line return valve; and
where the flushing comprises actuating the AWF pump thereby pumping, spraying, and flushing the AWF directly into the ink return line region proximate to, and downstream from, the in-line return valve, and therefrom flowing the AWF through the ink return line and into the ink waste tank of the inkjet printer system.

6. The method of claim 5, further comprising an AWF output valve having an input and an output, the input fluidly coupled to the output of the AWF pump and the output fluidly coupled to the ink return line region proximate to, and downstream from, the in-line return valve; and
where the flushing comprises opening the AWF output valve and actuating the AWF pump thereby pumping, spraying, and flushing the AWF directly into the ink return line region proximate to, and downstream from, the in-line return valve, and therefrom flowing the AWF through the ink return line and into the ink waste tank of the inkjet printer system.

7. The method of claim 1, where the flushing comprises pumping, spraying, and flushing the AWF directly into the ink return line region proximate to, and upstream from, the in-line return valve, and therefrom flowing the AWF through the ink return line, the in-line return valve, and into the ink waste tank of the inkjet printer system.

8. The method of claim 7, wherein an AWF pump has an input and an output, the input fluidly coupled to an AWF reservoir and the output fluidly coupled to the ink return line region proximate to, and upstream from, the in-line return valve; and
where the flushing comprises actuating the AWF pump thereby pumping, spraying, and flushing the AWF directly into the ink return line region proximate to, and upstream from, the in-line return valve, and therefrom flowing the AWF through the ink return line, the in-line return valve, and into the ink waste tank of the inkjet printer system.

9. The method of claim 8, further comprising an AWF output valve having an input and an output, the input fluidly coupled to the output of the AWF pump and the output fluidly coupled to the ink return line region proximate to, and upstream from, the in-line return valve; and
where the flushing comprises opening the AWF output valve and actuating the AWF pump thereby pumping, spraying, and flushing the AWF directly into the ink return line region proximate to, and upstream from, the in-line return valve, and therefrom flowing the AWF through the ink return line, the in-line return valve, and into the ink waste tank of the inkjet printer system.

10. A production inkjet printer system comprising:
a print head including a manifold fluidly coupled to a manifold ink input line and separately to a manifold ink purge output line (also referred to as a return line);
a return valve that is normally closed and in-line connected with the return line downstream from the manifold;
a first pump for driving ink from a fresh ink reservoir, through the manifold, the return line and the return valve, and thereby to an ink waste tank of the production inkjet printer system; and
a second pump for pumping aqueous wiper fluid, or an ink-diluting solvent, (also referred to as AWF) from an AWF reservoir to a return line region proximate to the return valve.

11. The production inkjet printer system of claim 10, further comprising:
an inkjet system controller, operatively coupled to memory, the return valve, the first pump, and the second pump; and
wherein the inkjet system controller, in response to executing program instructions, performs a method comprising:
in response to a manifold purge instruction, invoking a manifold purge operation by:
actuating the first pump and opening the return valve;
closing the return valve and turning OFF the first pump after determining an end to the manifold purge operation;
turning ON the second pump, after closing the return valve to start an AWF flush operation, and flushing with AWF the return line region proximate to the return valve, and therefrom flowing the AWF into the ink waste tank; and
turning OFF the second pump, after determining an end to the AWF flush operation.

12. The production inkjet printer system of claim 11, comprising:
a sprayer nozzle fluidly coupled with an output of the second pump which has an input fluidly coupled to an output of the AWF reservoir, the sprayer nozzle located inside the ink waste tank and oriented to spray AWF into an opening of at least one of an end of the return line, an output port of the return valve, or both; and
wherein the inkjet system controller, in response to executing program instructions, performs the flushing by:
pumping and spraying the AWF into the opening of at least one of an end of the return line, an output port of the return valve, or both, and thereby flushing with AWF the return line region proximate to the return valve, and therefrom flowing the AWF into the ink waste tank.

13. The production inkjet printer system of claim 11, wherein the second pump has an output fluidly coupled to an AWF output line which is fluidly coupled to the return line region proximate to, and downstream from, the return valve, and the second pump has an input fluidly coupled to an output of the AWF reservoir; and
wherein the inkjet system controller, in response to executing program instructions, performs the flushing by:
pumping and spraying the AWF directly into the return line region proximate to, and downstream from, the return valve, and therefrom flowing the AWF into the ink waste tank.

14. The production inkjet printer system of claim 13, further comprising an AWF output valve having an input and an output, the input fluidly coupled to the AWF output line and the output fluidly coupled to the return line region proximate to, and downstream from, the return valve; and
wherein the inkjet system controller, based on invoking the manifold purge instruction, opening the AWF output valve thereby pumping and spraying the AWF directly into the return line region proximate to, and downstream from, the return valve.

15. The production inkjet printer system of claim 11, wherein the second pump has an output fluidly coupled to an AWF output line which is fluidly coupled to the return line region proximate to, and upstream from, the return valve, and the second pump has an input fluidly coupled to an output of the AWF reservoir; and
wherein the inkjet system controller, in response to executing program instructions, performs the flushing by:
pumping and spraying the AWF directly into the return line region proximate to, and upstream from, the return valve, and therefrom flowing the AWF into the ink waste tank.

16. The production inkjet printer system of claim 11, wherein the first pump comprises a compressor air pump that has an output air-coupled to an upper region of the fresh ink reservoir above a fill level of the ink in the fresh ink reservoir, and in response to a first control signal from the inkjet system controller the first pump pumps air into the fresh ink reservoir creating a pneumatic air pressure driving force on the ink in the fresh ink reservoir thereby driving the ink from the fresh ink reservoir, through the manifold, the return line, the return valve, and thereby to the ink waste tank.

17. The production inkjet printer system of claim 16, further comprising a controllable valve that is normally open and located in an upper region of the fresh ink reservoir creating an air hole that equalizes air pressure in the fresh ink reservoir, the controllable valve being operatively coupled with the inkjet system controller; and
wherein during the manifold purge operation the inkjet system controller, closes the controllable valve and turns ON the first pump which pumps air into the fresh ink reservoir creating the pneumatic air pressure driving force on the ink in the fresh ink reservoir.

18. A production inkjet printer system comprising:
a print head including a manifold fluidly coupled to a manifold ink input line and separately to a manifold ink purge output line (also referred to as a return line);
a return valve that is normally closed and in-line connected with the return line downstream from the manifold;
a first pump for driving aqueous ink fluid from a fresh ink reservoir, through the manifold, the return line, and the return valve, and thereby into an ink waste tank of the production inkjet printer system;
an inkjet system controller, operatively coupled to memory, the return valve, and the first pump; and
wherein the inkjet system controller, in response to executing program instructions, performs a method comprising:
flushing, based on receiving the manifold purge instruction, with aqueous ink fluid the ink return line at an ink return line region proximate to the in-line return valve, and therefrom flowing the aqueous ink fluid into the ink waste tank of the production inkjet printer system.

19. The production inkjet printer system of claim 18, comprising a sensor that senses a closed or open state of the normally closed return valve, wherein the inkjet system controller is operatively coupled to the sensor, and wherein the inkjet system controller, in response to executing program instructions, performs a method comprising:
flushing, based on receiving the manifold purge instruction and until the sensor senses the normally closed return valve changing state from being open to being closed, with aqueous ink fluid the ink return line at an ink return line region proximate to the in-line return valve, and therefrom flowing the aqueous ink fluid into the ink waste tank of the production inkjet printer system.
